(19) United States
(12) Patent Application Publication
(10) Pub. No.: US 2021/0141981 A1
(43) Pub. Date: May 13, 2021

(54) STRUCTURAL NON-GRADIENT TOPOLOGY OPTIMIZATION METHOD BASED ON SEQUENTIAL KRIGING SURROGATE MODEL

(71) Applicant: DALIAN UNIVERSITY OF TECHNOLOGY, Dalian (CN)

(72) Inventors: Yangjun LUO, Dalian (CN); Jian XING, Dalian (CN); Zhan KANG, Dalian (CN)

(21) Appl. No.: 16/821,821

(22) Filed: Mar. 17, 2020

(30) Foreign Application Priority Data
Nov. 8, 2019 (CN) 2019110857979

(51) Int. Cl. G06F 30/23

(52) U.S. Cl. CPC G06F 30/23; G06F 2111/04

(57) ABSTRACT

A structural non-gradient topology optimization method based on a sequential Kriging surrogate model mainly comprises three parts: reduced series expansion of a material field of design domain, building of a non-gradient topology optimization model and solving optimization model using a sequential Kriging surrogate model algorithm. Design variables of the topology optimization problem are considerably reduced through the series expansion of a material-field function, and then the topology optimization problem involving fewer than 50 design variables can be effectively solved using the sequential Kriging surrogate model algorithm with an adaptive design space adjustment strategy. Without requiring the information of design sensitivity of a performance function, this method is suitable for solving complex multi-physical, multidisciplinary and highly nonlinear topology optimization problems. It not only inherits the simple form of density-based topology optimization model, but also makes the final topology clear and smooth in structural boundary.

### TECHNICAL FIELD

The present invention belongs to the field of structural and multidisciplinary optimization design, and relates to a structural non-gradient topology optimization method based on a sequential Kriging surrogate model. This method is suitable for the topology optimization design of machinery, instruments, aerospace and other complex equipment.

### BACKGROUND

Topology optimization is an important tool to solve the problem of optimal material layout design of structural and multidisciplinary optimization. At present, the main methods include density-based method, level set method and evolutionary structural optimization. Most of these methods derive adjoint-variable sensitivity information based on specific optimization problems, solve problems using the gradient-based algorithm, and are successfully applied in the innovative design of machinery, instruments, aerospace equipment, etc. However, for many problems in practical engineering, such as collision, (material, geometry, contact) nonlinearity, multi-physical problems, etc., the parsed sensitivity information cannot be obtained, and the performance function exhibits multi-peak characteristics. In these cases, the global solution cannot be obtained using the gradient-based algorithm.

The existing topology optimization business software (such as Optistruct, Tosca, etc.) all use the density-based method, which can only solve specific problems that are easy to derive sensitivity information, such as compliance topology optimization and frequency topology optimization, but cannot used for complex multidisciplinary and nonlinear topology optimization. Depending on material-field series expansion, on the basis of substantially reducing topology optimization design variables, the present invention proposes an optimization algorithm based on a sequential Kriging surrogate model, which can effectively solve the problem of structural topology optimization. This method does not require information of design sensitivity, which greatly reduces the difficulty of solving topology optimization problem. This method has no checkerboard pattern and mesh dependency phenomenon, so that a structural topology structure with smooth mesh boundaries can be obtained, and is suitable for solving multidisciplinary, multi-physical problems and other complex structural material layout optimization problems.

### SUMMARY

In view of the disadvantages of the traditional topology optimization method that needs complex mathematical operation process to derive gradient information and has high barrier to use, the present invention provides an effective non-gradient topology optimization method. The method has good generality, does not require information of design sensitivity, can be directly applied to solve complex multidisciplinary optimization and multi-physical problems, and is easy to interface with various finite element business software and self-developed software. The present invention is suitable for material layout optimization design of machinery, instruments, aerospace equipment, and other fields.

To achieve the above purpose, the present invention adopts the following technical solution:

A structural non-gradient topology optimization method based on a sequential Kriging surrogate model, mainly comprising three parts, i.e. reduced series expansion of a material field of design domain, building of a non-gradient topology optimization model and using a sequential Kriging surrogate model algorithm, specifically comprising the following steps:

Step 1: Reduced Series Expansion of Material Field of Design Domain 1.1) determining structural design domain and defining material-field correlation: defining a material-field correlation function in the structural design domain as C(x₁, x₂)=exp(−∥x₁-x₂∥²/l_{c}²), where x₁ and x₂ represent spatial positions of any two observation points, l_{c} represents correlation length, and ∥ ∥ represents 2-norm; uniformly selecting Nₚ observation points in the structural design domain, calculating correlation among all the observation points through the correlation function, and forming a Nₚ×Nₚ-dimensional correlation matrix. The correlation matrix is a symmetric positive-definite matrix with the diagonal of 1;

1.2) conducting eigenvalue decomposition on the correlation matrix in step 1.1), sorting eigenvalues λⱼ(j=1,2, . . .,Nₚ) from large to small; retaining the eigenvalues of the first M orders and corresponding eigenvectors, wherein the retention criterion is: the sum of the selected eigenvalues accounts for 99%-99.9% of the sum of all eigenvalues;

1.3) describing the material field in the form of reduced series expansion, namely

$$φ ( x ) \approx {\sum }_{{ }^{j = 1}}^{M} {η}_{j} \frac{{ψ}_{j}^{T} {C}_{d} ( x )}{\sqrt{{λ}_{j}}} ,$$

ϵΩ_{des}, where ηⱼ (j=1,2, . . .,M) represents a material-field expansion coefficient, λⱼ and Ψⱼ represent the extracted eigenvalues and eigenvectors, respectively, in step 1.2), C_{d}(x) represents a correlation vector formed in step 1.1) by calculating the correlation function between any point in the space and an observation point, and Ω_{des} represents the design domain.

Step 2: Building of Non-gradient Topology Optimization Model

2.1) conducting finite element mesh partition on the entire structure, establishing a mapping relationship between the material field in step 1.3) and the relative density of each finite element in the design domain as

$${ρ}_{e} = {ρ}_{min} + \frac{1 + \text{?}}{2} ( 1 - {ρ}_{min} ) , \\ \text{?} \text{indicates text missing or illegible when filed}$$

(e=1,2, . . ., Nₑₗₑ), where ρₑ represents the relative density of each finite element, ρₘᵢₙ represents the lower limit of the relative density, [symbol] represents a Heaviside mapping function of φ(xₑ), the smoothing parameter thereof stepwise increases from 0 to 20 according to the adjustment of the design space, xₑ represents a coordinate of the elements in the design domain, and Nₑₗₑ represents the number of the finite elements in the design domain.

2.2) building continuum non-gradient topology optimization model as follows:

$${min}_{η = {\{ {η}_{1} , {η}_{2} , … , {η}_{M} \}}^{T}} f ( u , ρ )$$

$$s . t . G ( u ) = 0 \\ {g}_{k} ( u , ρ ) \leq 0 , ( k = 1 , 2 , … \text{?} \\ {η}^{T} {W}_{i} η \leq 1 , ( i = 1 , 2 , … \text{?} \\ \text{?} \text{indicates text missing or illegible when filed}$$

where ρ represents the vector of design variables, ƒ(u, ρ) represents an objective performance function, u represents the structural response obtained by finite element analysis, and ρ represents a η-related vector composed of the element density ρₑ in the design domain; G(u)=0 represents a finite element equilibrium equation, η^{T}Wᵢη≤1 represents a bounded field boundary constraint, gₖ(u, ρ)≤0 represents other performance or volume constraint function, and n_{c} represents the number of the constraint functions.

Transforming the optimization model into an unconstrained optimization form:

$${min}_{η} {f}_{obj} ( η ) = f ( u , ρ ) + {p}_{0} \cdot {max}_{k , i} ( {g}_{k} , ( {η}^{T} {W}_{i} η - 1 ) , 0 )$$

where p₀ represents a penalization factor, the value thereof is determined according to p₀=10^{floor(1+log}^{₁₀}^{|ƒ(u,ρ)|)}, and floor( [symbol] represents a round down function; the unconstrained processing of the model includes other internal and external penalization processing methods.

Step 3: Solving Optimization Model Using Sequential Kriging Surrogate Model Algorithm

3.1) forming a series of unconstrained sub optimization problems using an adaptive design space adjustment strategy in combination with the unconstrained optimization model built in step 2.2). The design space adjustment strategy comprising the following steps:

a) selecting an initial sample point η₀ according to the volume constraint, making φ(x)=(2ƒᵥ−1), x ϵΩ_{des}, where ƒᵥ represents an allowable material volume ratio.

b) determining an initial sub design space as Ω₀={|72-72 _{0|∞}≤r₀}, where r₀ is obtained according to the formula:

$${r}_{0} = max r$$

$$s . t . {\vert η - {η}_{0} \vert}_{∞} \leq r$$

$$ζ - 1 \leq φ ( {x}_{e} ) \leq ζ , ( e = 1 , 2 , … , {N}_{e l e} )$$

where r₀ represents the size of the initial design space, ||₂₈ represents an infinite norm, and ζ is a parameter that defines the upper and lower bounds of the material field; the value is 0.5 (if there is no volume constraint) or ƒᵥ (if there is a volume constraint).

c) solving the current k^{th} sub optimization problem using the Kriging surrogate model optimization algorithm, and by taking the optimal solution as the next design space center 72 ₖ, determining a new sub design space as:

Ωₖ₊₁={|η-η_{k|∞}≤rₖ₊₁} (k=0,1,2, . . ., rₖ₊₁=0.95 rₖ

where the subscript k k+1 represents the number of sub optimization problem;

d) when the optimization result meets the convergence criterion |ηₖ-η_{k-1|∞}≤0.001, ending optimization;

3.2) for each sub optimization design problem, solving using the Kriging surrogate model algorithm, the steps being as follows:

a) randomly selecting 100-200 initial samples in each sub design domain using Latin hypercube sampling;

b) adding sample points using a combination of maximizing the expectation improvement (EI) and minimizing the prediction (MP) of the surrogate model, and performing the solving process;

c) when meeting the stopping criterion (a plurality of consecutive newly-added samples cannot decrease the value of objective function), the sub optimization problem converges.

Further, the correlation length l_{c} in step 1.1) is selected as 30%-40% of the size of the short side of the rectangular design domain.

Further, for the optimization process conducted using the Kriging surrogate model algorithm in each sub design space in step 3.1), the optimization solving algorithm further includes radial basis function, support vector machine, artificial neural network and other surrogate model methods.

The present invention has the advantageous effects that: the method does not require information of design sensitivity of a performance function, and is suitable for solving complex multi-physical, multidisciplinary, and highly nonlinear topology optimization problems. It not only inherits the simple form of density-based topology optimization model, but also makes the final topology clear and smooth in structural boundary. The method is convenient to integrate various business software and self-developed finite element software, and is convenient for popularization in engineering application.

### BRIEF DESCRIPTION OF THE DRAWINGS

FIG. 1 shows a design condition of a biomimetic soft robotic provided by embodiments of the present invention; in the figure: A: 195mm; B: 50 mm; C: 40 mm; D: 5 mm; E: 10 mm; F: 1.5 mm

FIG. 2 shows an optimized topology structure of a biomimetic soft robotic.

FIG. 3(a) is a displacement and deformation diagram showing a hollow structure of a biomimetic soft robotic.

FIG. 3(b) is a displacement and deformation diagram showing an optimized structure of a biomimetic soft robotic.

### DETAILED DESCRIPTION

Specific embodiments of the present invention are described below in detail in combination with the technical solution and accompanying drawings.

A structural non-gradient topology optimization method based on a sequential Kriging surrogate model, in which a structural topology is mapped through a material-field function, and material-field control parameters are used as design variables. The standard topology optimization model is solved by using the adaptive design space adjustment strategy and the Kriging surrogate model method. The whole process does not require deriving gradient information, which is simple and efficient.

FIG. 1 depicts the optimization problem of a biomimetic soft robotic made of super-elastic material. The specific dimensions are shown in the figure. The square area of 40 mm×40 mm in the figure is the structural design domain, the entire structure is exposed to air pressure at the periphery, and the bottom of the structure is in frictionless contact with the ground. A 3^{rd} order Ogden super-elastic material is used for the soft robotic. The lower left corner of the structure is hinged, and the lower right corner thereof is connected to a spring. The optimization goal is to maximize the absolute value of horizontal displacement of the lower right corner.

Step 1: Reduced Series Expansion of Material Field of Design Domain

1.1) selecting correlation function and correlation length: selecting a correlation function C(x₁,x₂)=exp(−∥x₁-x₂∥²/l_{c}²); uniformly selecting 1600 observation points in the design domain, the correlation length l_{c}=12 mm ; calculating correlation among all the observation points, and forming a correlation matrix. The correlation matrix is a symmetric positive-definite matrix with the diagonal of 1;

1.2) conducting eigenvalue decomposition on the correlation matrix in step 1.1), sorting eigenvalues from large to small; retaining the eigenvalues of the first 50 orders and corresponding eigenvectors;

1.3) describing the material field in the form of reduced series expansion, namely

$$φ ( x ) \approx {\sum }_{j = 1}^{50} {η}_{j} \frac{{ψ}_{j}^{T} {C}_{d} ( x )}{\sqrt{{λ}_{j}}} ,$$

x ϵΩ_{des}, where ηⱼ(j=1, 2, . . .,50) represents a material-field expansion coefficient, λⱼ and Ψⱼ represent the extracted eigenvalues and eigenvectors, respectively, in 1.2), C_{d}(x) represents a correlation vector formed in step 1.1) by calculating the correlation function between any point in the space and an observation point, and Ω_{des} represents the design domain.

Step 2: Building of Non-gradient Topology Optimization Model

2.1) conducting finite element mesh partition on the entire structure, dividing the design domain into 1600 elements, establishing a mapping relationship between the material field in step 1.3) and the relative density of each finite element in the design domain as

$${ρ}_{e} = {ρ}_{min} + \frac{1 + \text{?}}{2} ( 1 - {ρ}_{min} ) , \\ \text{?} \text{indicates text missing or illegible when filed}$$

(e=1,2, . . .,1600), where ρ_{c} represents the relative density of each finite element, ρₘᵢₙ=0.001, [symbol] represents a Heaviside mapping function of φ(xₑ), the smoothing parameter thereof stepwise increases from 0 to 20 according to the adjustment of the design space, and xₑ represents a coordinate of the elements in the design domain.

2.2) by taking the maximization of absolute value of displacement of the lower right corner as a goal and taking that the relative material volume does not exceed 50% as a constraint condition, building a non-gradient topology optimization model; and conducting unconstrained processing on the original topology optimization according to the formula

$${min}_{η} {f}_{obj} ( η ) = f ( u , ρ ) + {p}_{0} \cdot {max}_{k , i} ( {g}_{k} , ( {η}^{T} {W}_{i} η - 1 ) , 0 ) .$$

Step 3: Solving Optimization Model Using Sequential Kriging Surrogate Model Algorithm

3.1) forming a series of unconstrained sub optimization problems using an adaptive design space adjustment strategy in combination with the unconstrained optimization model built in step 2.2). The design space adjustment strategy, comprising the following steps:

a) selecting an initial sample point η₀ according to the volume constraint, making φ(x)=(2ƒᵥ−1), X ϵΩ_{des}, where ƒᵥ=50%.

b) determining an initial sub design space as Ω₀={η-η_{0|∞}≤r₀}, where r₀ is obtained according to the formula:

$${r}_{0} = max r$$

$$s . t . {\vert η - {η}_{0} \vert}_{∞} \leq r$$

$$ζ - 1 \leq φ ( {x}_{e} ) \leq ζ , ( e = 1 , 2 , … , 1600 )$$

where r₀ represents the size of the initial design space, | |_{∞}represents an infinite norm, and ζ=50%;

c) solving the current k^{th} sub optimization problem using the Kriging surrogate model optimization algorithm, and by taking the optimal solution as the next design space center ηₖ, determining a new sub design space as:

Ωₖ₊₁={|η-η_{k|∞}≤rₖ₊₁}(k=0,1,2,. . ., rₖ₊₁=0.95 rₖ

where k k+1 represents the number of sub optimization problem;

d) when the optimization result meets the convergence criterion |ηₖ-η_{k-1|∞}≤1.0.001, ending optimization.

3.2) for each sub optimization design problem in step 3.1), solving using the Kriging surrogate model algorithm, the steps being as follows:

a) randomly selecting 100 initial samples in each sub design domain using Latin hypercube sampling;

b) adding sample points using a combination of maximizing the expectation improvement (EI) and minimizing the prediction (MP) of the surrogate model, and performing the optimization process;

c) when meeting the stopping criterion (a plurality of consecutive newly-added samples cannot decrease the value of objective function), the sub optimization problem converges.

The structural optimal material layout obtained using the sequential Kriging surrogate model optimization method with an adaptive design space adjustment strategy is shown in FIG. 2. The displacement and deformation of the optimized topology structure and hollow structure are shown in FIG. 3. The absolute value of displacement of the lower right corner of the hollow structure in FIG. 3(a) is 6.00 mm, and the absolute value of displacement of the corner of the optimized structure in FIG. 3(b) is 10.63 mm The results indicate that the optimization method is correct and effective.

By taking a small amount of material-field control parameters as design variables, the essence of the present invention is to solve the topology optimization problem using the sequential Kriging surrogate model optimization method without information of design sensitivity. Any methods that simply or partly modify the optimization model and method in above-mentioned steps (for example, using other design space adjustment strategy, changing an objective function or constraining specific form or the like) do not, deviate from the scope of the present invention.

1. A structural non-gradient topology optimization method based on a sequential Kriging surrogate model, comprising three parts, i.e. reduced series expansion of a material field of design domain, building of a non-gradient topology optimization model and solving using a sequential Kriging surrogate model algorithm, specifically comprising the following steps:
step 1: reduced series expansion of material field of design domain 1.1) determining structural design domain and defining material-field correlation:
defining a material-field correlation function in the structural design domain as C (x₁,x₂)=exp(−∥x₁-x₂∥²/l_{c}²), where x₁ and x₂ represent spatial positions of any two observation points, l_{c} represents correlation length, and ∥ ∥ represents 2-norm; uniformly selecting Nₚ observation points in the structural design domain, calculating correlation among all the observation points through the correlation function, and forming a Nₚ×Nₚ-dimensional correlation matrix, the correlation matrix is a symmetric positive-definite matrix with the diagonal of 1;
1.2) conducting eigenvalue decomposition on the correlation matrix instep 1.1), sorting eigenvalues from large to small; retaining the eigenvalues of the first M orders and corresponding eigenvectors, wherein the retention criterion is: the sum of the selected eigenvalues accounts for 99%-99.9% of the sum of all eigenvalues;
1.3) describing the material field in the form of reduced series expansion, namely
$$φ ( x ) \approx {\sum }_{{ }^{j = 1}}^{M} {η}_{j} \frac{{ψ}_{j}^{T} {C}_{d} ( x )}{\sqrt{{λ}_{j}}} ,$$
x ϵΩ_{des}, where ηⱼ (j=1, 2, . . .,M) represents a material-field expansion coefficient, λⱼ and Ψⱼ represent the extracted eigenvalues and eigenvectors, respectively, in step 1.2), C_{d}(x) represents a correlation vector formed in step 1.1) by calculating the correlation function between any point in the space and an observation point, and Ω_{des} represents the design domain;
step 2: building of non-gradient topology optimization model
2.1) conducting finite element mesh partition on the entire structure, establishing a mapping relationship between the material field in step 1.3)and the relative density of each finite element in the design domain as
$${ρ}_{e} = {ρ}_{min} + \frac{1 + \text{?}}{2} ( 1 - {ρ}_{min} ) , \\ \text{?} \text{indicates text missing or illegible when filed}$$
(e=1, 2, . . ., Nₑₗₑ), where ρₑ represents the relative density of each finite element, ρₘᵢₙ represents the lower limit of the relative density, [symbol] represents a Heaviside mapping function of φ(xₑ)), the smoothing parameter thereof stepwise increases from 0 to 20 according to the adjustment of the design space, xₑ represents a coordinate of the elements in the design domain, and Nₑₗₑ represents the number of the finite elements in the design domain;
2.2) building continuum non-gradient topology optimization model as follows:
$${min}_{η = {\{ {η}_{1} , {η}_{2} , … , {η}_{M} \}}^{T}} f ( u , ρ )$$
$$s . t . G ( u ) = 0 \\ {g}_{k} ( u , ρ ) \leq 0 , ( k = 1 , 2 , … \text{?} \\ {η}^{T} {W}_{i} η \leq 1 , ( i = 1 , 2 , … \text{?} \\ \text{?} \text{indicates text missing or illegible when filed}$$
where η represents the vector of design variables, ƒ(u,ρ) represents an objective performance function, u represents the structural response obtained by finite element analysis, and ρ represents a η-related vector composed of the element density ρ, in the design domain; G(u)=0 represents a finite element equilibrium equation, η^{T}W, η≤1 represents a bounded field boundary constraint, gₖ (u,ρ)≤0 represents other performance or volume constraint function, and n_{c} represents the number of constraint functions; transforming the optimization model into an unconstrained optimization form, and conducting unconstrained processing;
step 3: solving optimization model using sequential Kriging surrogate model algorithm 3.1) forming a series of unconstrained sub optimization problems using an adaptive design space adjustment strategy in combination with the unconstrained optimization model built in step 2.2), the design space adjustment strategy comprising the following steps:
a) selecting an initial sample point η₀ according to the volume constraint, and making φ(x)=(2ƒᵥ−1), x ϵΩ_{des}, where ƒᵥ represents an allowable material volume ratio;
b) determining an initial sub design space as Ω₀={|η-η_{0|∞}≤r₀}, where r₀ is obtained according to the formula:
$${r}_{0} = max r$$
$$s . t . {\vert η - {η}_{0} \vert}_{∞} \leq r$$
$$ζ - 1 \leq φ ( {x}_{e} ) \leq ζ , ( e = 1 , 2 , … , {N}_{e l e} )$$
where r₀ represents the size of the initial design space, | |_{∞}represents an infinite norm, and ζ is a parameter that defines the upper and lower bounds of the material field;
c) solving the current k^{th} sub optimization problem using the Kriging surrogate model optimization algorithm, and by taking the optimal solution as the next design space center ηₖ, determining a new sub design space as:
Ωₖ₊₁={|η-η_{k|∞}≤rₖ₊₁}(k=0,1,2,. . ., rₖ₊₁=0.95 rₖ
where the subscript k k+1 represents the number of sub optimization problem;
d) when the optimization result meets the convergence criterion |ηₖ-η_{k-1|∞,} ≤0.001, ending optimization;
3.2) for each sub optimization design problem, solving using the Kriging surrogate model algorithm, the steps being as follows:
a) randomly selecting 100-200 initial samples in each sub design domain using Latin hypercube sampling;
b) adding sample points using a combination of maximizing the expectation improvement (EI) and minimizing the prediction (MP) of the surrogate model, and performing the solving process;
c) when meeting the stopping criterion (a plurality of consecutive newly-added samples cannot decrease the value of an objective function), the sub optimization problem converges.

2. The structural non-gradient topology optimization method based on a sequential Kriging surrogate model according to claim 1, wherein, the correlation length l_{c} in step 1.1) is selected as 30%-40% of the size of the short side of the rectangular design domain.

3. The structural non-gradient topology optimization method based on a sequential Kriging surrogate model according to claim 1, wherein, the unconstrained optimization form in step 2.2) is:
$${min}_{η} {f}_{obj} ( η ) = f ( u , ρ ) + {p}_{0} \cdot {max}_{k , i} ( {g}_{k} , ( {η}^{T} {W}_{i} η - 1 ) , 0 ) ,$$
where p₀ represents a penalization factor, the value thereof is determined according to p₀=10^{floor(1+log}^{₁₀}^{|ƒ(u,ρ(η))|)}, and floor(Π represents a round down function; the unconstrained processing of the model includes other internal and external penalization processing modes.

4. The structural non-gradient topology optimization method based on a sequential Kriging surrogate model according to claim 1, wherein, for the optimization solving conducted using the Kriging surrogate model algorithm in each sub design space in step 3.1), the optimization solving algorithm further includes radial basis function, support vector machine, artificial neural network and other surrogate model methods.

5. The structural non-gradient topology optimization method based on a sequential Kriging surrogate model according to claim 3, wherein, for the optimization solving conducted using the Kriging surrogate model algorithm in each sub design space in step 3.1), the optimization solving algorithm further includes radial basis function, support vector machine, artificial neural network and other surrogate model methods.

6. The structural non-gradient topology optimization method based on a sequential Kriging surrogate model according to claim 1, wherein, for the value of ζ in step 3.1), the value is 0.5 if there is no volume constraint, and the value is ƒ, if there is a volume constraint.

7. The structural non-gradient topology optimization method based on a sequential Kriging surrogate model according to claim 3, wherein, for the value of ζ in step 3.1), the value is 0.5 if there is no volume constraint, and the value is ƒᵥ if there is a volume constraint.

8. The structural non-gradient topology optimization method based on a sequential Kriging surrogate model according to claim 4, wherein, for the value of ζ in step 3.1), the value is 0.5 if there is no volume constraint, and the value is ƒᵥ if there is a volume constraint.
